(19) United States
(12) Patent Application Publication
(10) Pub. No.: US 2024/0255643 A1
(43) Pub. Date: Aug. 1, 2024

(54) DISTANCE MEASUREMENT CAMERA MODULE

(71) Applicant: LG INNOTEK CO., LTD., Seoul (KR)

(72) Inventor: Keal Doo MOON, Seoul (KR)

(21) Appl. No.: 18/560,596

(22) PCT Filed: May 10, 2022
(86) PCT No.: PCT/KR2022/006647

§ 371 Date: Nov. 13, 2023

(30) Foreign Application Priority Data
May 10, 2021 (KR) 10-2021-0059893

(51) Int. Cl. G01S 17/89; G01S 7/481; G01S 7/4863; G01S 17/10

(52) U.S. Cl. CPC G01S 17/89; G01S 7/4811; G01S 7/4815; G01S 7/4863; G01S 17/10

(57) ABSTRACT

A distance measurement camera module according to an embodiment includes a light emitting unit; and a light receiving unit including an image sensor, wherein the light emitting unit comprises: a plurality of light sources; and a first optical member disposed on the plurality of light sources, wherein the plurality of light sources comprises: a first light source spaced apart from the first optical member at a first height; and a second light source spaced apart from the first optical member at a second height, wherein the first height is smaller than the second height, and wherein an output light emitted through each of the first and second light sources is focused at different positions.

### CROSS-REFERENCE TO RELATED APPLICATIONS

This application is the U.S. national stage application of International Patent Application No. PCT/KR2022/006647, filed May 10, 2022, which claims the benefit under 35 U.S.C. § 119 of Korean Application No. 10-2021-0059893, filed May 10, 2021, the disclosures of each of which are incorporated herein by reference in their entirety.

### TECHNICAL FIELD

An embodiment relates to a camera module capable of measuring a distance to an object located in front.

### BACKGROUND ART

A camera module performs a function of photographing objects and saving them as images or videos, and are installed in various applications. In particular, the camera module is manufactured in an ultra-small size and is applied to not only portable devices such as smartphones, tablet PCs, and laptops, but also drones and vehicles, providing various functions.

Recently, demand and supply for 3D content are increasing. Accordingly, various technologies that can form 3D content by capturing depth information using a camera module are being researched and developed. For example, technologies that can determine depth information include technology using stereo cameras, technology using structured light cameras, technology using DFD (Depth from defocus) cameras, and technologies using TOF (Time of Flight) camera modules.

First, the technology using stereo cameras is a technology that generates depth information using differences in distance, spacing, etc. that occur in the left and right parallax of images received through a plurality of cameras, for example, each camera disposed on the left and right.

In addition, the technology using a structured light camera is a technology that generates depth information using a light source arranged to form a set pattern, and the technology using a DFD (Depth from defocus) camera is a technology that uses defocusing and generates depth information using multiple images with different focuses taken in the same scene.

In addition, TOF (Time of Flight) camera is a technology that generates depth information by calculating the distance to the object by measuring the time when light emitted from a light source toward the object is reflected by the object and returns to the sensor. These TOF cameras have recently been attracting attention because they have the advantage of being able to acquire depth information in real time.

However, TOF cameras have safety issues because they use light in a relatively high wavelength band. In detail, the light used in TOF cameras generally uses light in an infrared wavelength band, and when the light enters sensitive areas of a person, such as the eyes or skin, there is a problem that it can cause various injuries and diseases.

Additionally, as the distance between the TOF camera and the object increases, the light energy per area reaching the object decreases, and as a result, the light energy reflected and returned to the object can also decrease. Accordingly, there is a problem that the accuracy of depth information about objects is reduced.

Additionally, as described above, when an object is located at a long distance, stronger light can be emitted toward the object in order to improve the accuracy of the depth information of the object. However, in this case, issues regarding increased power consumption of the camera and safety issues can arise.

In addition, a 3D camera capable of detecting the above-described depth information can control a radiation angle of the output light according to the distance to the object, as shown in issued patent KR 10-1538395. In detail, the 3D camera can diffuse light emitted from a random radiation angle to a different radiation angle by moving a carrier according to the distance to the object, and through this, light can be emitted to an object located near or far away. However, the carrier including magnets, coils, etc. occupies a relatively large volume within the 3D camera, and because the carrier requires a moving distance within the camera, it is difficult to manufacture the camera small and light. In addition, in order to control the radiation angle of the output light in the camera, the moving distance of the carrier requires high precision, but there is a limit to precision. Additionally, when a separate magnetic field is formed around the camera, interference can occur in control of the carrier due to the influence of the magnetic field, and in this case, it is difficult to effectively control the radiation angle through movement of the carrier.

Therefore, a new camera module that can solve the above-mentioned problems is required.

### DISCLOSURE

### Technical Problem

The embodiment provides a camera module that can effectively determine depth information of an object by providing optimal output light depending on the distance to the object.

Additionally, the embodiment provides a camera module that can inhibit output light exceeding a set intensity from being directly irradiated to sensitive areas such as human eyes and skin.

Additionally, the embodiment provides a camera module that has a simple structure and can be provided in a slim form.

### Technical Solution

A distance measurement camera module according to the embodiment comprises a light emitting unit; and a light receiving unit including an image sensor, wherein the light emitting unit comprises: a plurality of light sources; and a first optical member disposed on the plurality of light sources, wherein the plurality of light sources comprises: a first light source spaced apart from the first optical member at a first height; and a second light source spaced apart from the first optical member at a second height, wherein the first height is smaller than the second height, and wherein an output light emitted through each of the first and second light sources is focused at different positions.

In addition, a difference between the first height and the second height is 250 [symbol] to 500 [symbol] .

In addition, a first output light emitted from the first light source and emitted through the first optical member forms light of a point pattern at a position spaced apart by a first distance, and a second output light emitted from the second light source and emitted through the first optical member forms light of a surface pattern at a position spaced apart by a second distance.

In addition, the second distance is closer than the first distance.

In addition, the first optical member includes diffractive optical elements (DOE, Diffractive Optic Elements), and a number of the diffractive optical elements is less than or equal to a number of the plurality of light sources.

In addition, the diffractive optical elements includes a first diffractive optical element disposed on the first light source; and a second diffractive optical element disposed on the second light source.

In addition, the first optical member includes a first lens unit disposed on the diffractive optical elements and includes including at least one lens.

In addition, the first optical member includes a first lens unit disposed between the plurality of light sources and the diffractive optical elements including at least one lens.

In addition, the first lens unit includes a first-first lens unit disposed at a region corresponding to the first light source; and a first-second lens unit disposed at a region corresponding to the second light source.

In addition, the first optical member includes a liquid crystal layer disposed between the plurality of light sources and the diffractive optical elements.

### Advantageous Effects

A distance measurement camera module according to an embodiment can include a first optical member and a plurality of light sources arranged at different intervals. In detail, the light source can include a first light source spaced apart from the first optical member at a first height and a second light source spaced apart from the first optical member at a second height. Accordingly, the camera module can provide optimal output light toward the object by selectively driving at least one light source selected from the first and second light sources according to the distance to the object, and can effectively grasp the depth information of the object.

In addition, the distance measurement camera module provides optimal output light according to the distance to the object, thereby inhibiting output light exceeding a set intensity from being directly incident on sensitive areas of a person, such as eyes and skin.

In addition, the light emitting unit of the distance measurement camera module can omit the configuration for controlling the form of output light depending on the distance to the object, for example, an actuator that controls the position of the light source and/or the first optical member. Therefore, the camera module has a simple structure and can be provided to be slimmer.

### DESCRIPTION OF DRAWINGS

FIG. 1 is a configuration diagram of a distance measurement camera module according to an embodiment.

FIG. 2 is a configuration diagram of a light emitting unit and a light receiving unit in a distance measurement camera module according to an embodiment.

FIG. 3 is a diagram showing one side of a light source according to an embodiment.

FIG. 4 is a diagram for explaining an optical signal generated by a light emitting unit in a distance measurement camera module according to an embodiment.

FIG. 5 is a diagram showing the arrangement of a light emitting unit in a distance measurement camera module according to an embodiment.

FIGS. 6(a) and 6(b) are diagrams for explaining a light pattern of the output light according to an embodiment.

FIGS. 7 to 15 are diagrams showing different arrangements of light emitting units in a distance measurement camera module according to an embodiment.

FIGS. 16 and 17 are perspective views of a mobile terminal and a vehicle to which a distance measurement camera module according to an embodiment is applied.

### DETAILED DESCRIPTION OF THE EMBODIMENTS

Hereinafter, embodiments of the present invention will be described in detail with reference to the accompanying drawings.

However, the spirit and scope of the present invention is not limited to a part of the embodiments described, and can be implemented in various other forms, and within the spirit and scope of the present invention, one or more of the elements of the embodiments can be selectively combined and replaced.

In addition, unless expressly otherwise defined and described, the terms used in the embodiments of the present invention (including technical and scientific terms can be construed the same meaning as commonly understood by one of ordinary skill in the art to which this invention belongs, and the terms such as those defined in commonly used dictionaries can be interpreted as having a meaning that is consistent with their meaning in the context of the relevant art. Further, the terms used in the embodiments of the present invention are for describing the embodiments and are not intended to limit the present invention.

In this specification, the singular forms can also include the plural forms unless specifically stated in the phrase, and can include at least one of all combinations that can be combined in A, B, and C when described in “at least one (or more) of A (and), B, and C”. Further, in describing the elements of the embodiments of the present invention, the terms such as first, second, A, B, (a), and (b) can be used.

These terms are only used to distinguish the elements from other elements, and the terms are not limited to the essence, order, or order of the elements. In addition, when an element is described as being “connected”, “coupled”, or “contacted” to another element, it can include not only when the element is directly “connected” to, “coupled” to, or “contacted” to other elements, but also when the element is “connected”, “coupled”, or “contacted” by another element between the element and other elements.

In addition, when described as being formed or disposed “on (over)” or “under (below)” of each element, the “on (over)” or “under (below)” can include not only when two elements are directly connected to each other, but also when one or more other elements are formed or disposed between two elements. Further, when expressed as “on (over)” or “under (below)”, it can include not only the upper direction but also the lower direction based on one element.

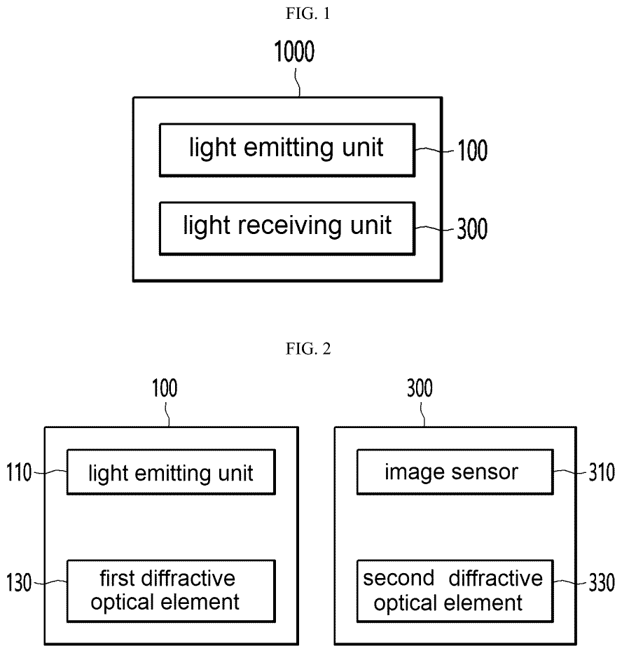

FIG. 1 is a configuration diagram of a distance measurement camera module according to an embodiment.

Referring to FIG. 1, a camera module 1000 according to an embodiment can include a light emitting unit 100 and a light receiving unit 300.

The light emitting unit 100 can emit light. The light emitting unit 100 can emit light of a set intensity in a set direction. The light emitting unit 100 can emit light in a visible light to infrared wavelength band. The light emitting unit 100 can form an optical signal. The light emitting unit 100 can form an optical signal set by a signal applied from a control unit (not shown). The light emitting unit 100 can generate and output an output light signal in the form of a pulse wave or a continuous wave by an applied signal. Here, the continuous wave can be in the form of a sinusoid wave or a square wave. Additionally, the optical signal can refer to an optical signal incident on an object. The light signal output by the light emitting unit 100 can be an output light or an output light signal based on the camera module 1000, and the light output by the light emitting unit 100 can be an incident light or an incident light signal based on the object.

The light emitting unit 100 can irradiate the light signal to the object for a predetermined exposure period (integration time). Here, the exposure period can mean one frame period. For example, if the frame rater of the camera module 1000 is 30 FPS (Frame per second), the period of one frame can be 1/30 second.

The light emitting unit 100 can output a plurality of optical signals having the same frequency. Additionally, the light emitting unit 100 can output a plurality of optical signals having different frequencies. For example, the light emitting unit 100 can repeatedly output a plurality of optical signals having different frequencies according to a set rule. Additionally, the light emitting unit 100 can simultaneously output a plurality of optical signals having different frequencies.

The light receiving unit 300 can be disposed adjacent to the light emitting unit 100. For example, the light receiving unit 300 can be arranged side by side with the light emitting unit 100. The light receiving unit 300 can receive light. The light receiving unit 300 can detect light reflected by the object, for example, input light. In detail, the light receiving unit 300 can detect light emitted from the light emitting unit 100 and then reflected on the object. The light receiving unit 300 can detect light in a wavelength band corresponding to the light emitted by the light emitting unit 100.

The camera module 1000 can further include a control unit (not shown). The control unit can be connected to at least one of the light emitting unit 100 and the light receiving unit 300. The control unit can control the operation of at least one of the light emitting unit 100 and the light receiving unit 300.

For example, the control unit can include a first control unit (not shown) that controls the light emitting unit 100. The first control unit can control an optical signal applied to the light emitting unit 100. The first control unit can control the intensity, frequency pattern, etc. of the optical signal.

Additionally, the control unit can include a second control unit (not shown) that controls the light emitting unit 100. The second control unit can control at least one light source 110 included in the light emitting unit 100. For example, the second control unit can control a driving signal applied to at least one light source among the plurality of light sources 110.

That is, the control unit can control the operation of the light emitting unit 100 according to the size, location, shape, etc. of an object located in front of the camera module 1000. In detail, the control unit can control the intensity of light emitted from the light emitting unit 100, the size of the light pattern, and the shape of the light pattern, etc., depending on the location of the object.

In addition, although not shown in the drawing, the camera module 1000 can further include a coupling unit (not shown) and a connection unit (not shown).

The coupling unit can be connected to an optical device that will be described later. The coupling unit can include a circuit board and a terminal disposed on the circuit board. The terminal can be a connector for physical and electrical connection with the optical device.

The connection unit can be disposed between the coupling unit and a substrate of the camera module 1000, which will be described later. The connection unit can connect the substrate and the coupling unit. For example, the connection unit can include a flexible PCB (FBCB), and can electrically connect the substrate and the circuit board the coupling unit. Here, the substrate can be at least one of a first substrate of the light emitting unit 100 and a second substrate of the light receiving unit 300.

The camera module 1000 can be a time of flight (TOF) camera that emits light toward an object and calculates depth information of the object based on the time or phase difference of the light reflected by the object and returned.

Hereinafter, a light emitting unit and a light receiving unit according to an embodiment will be described in more detail with reference to the drawings.

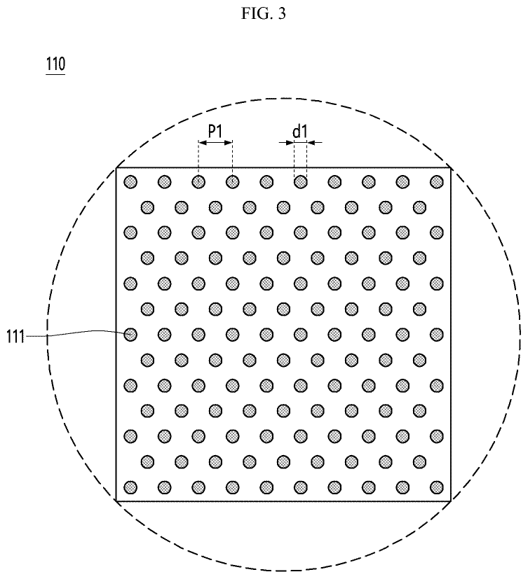

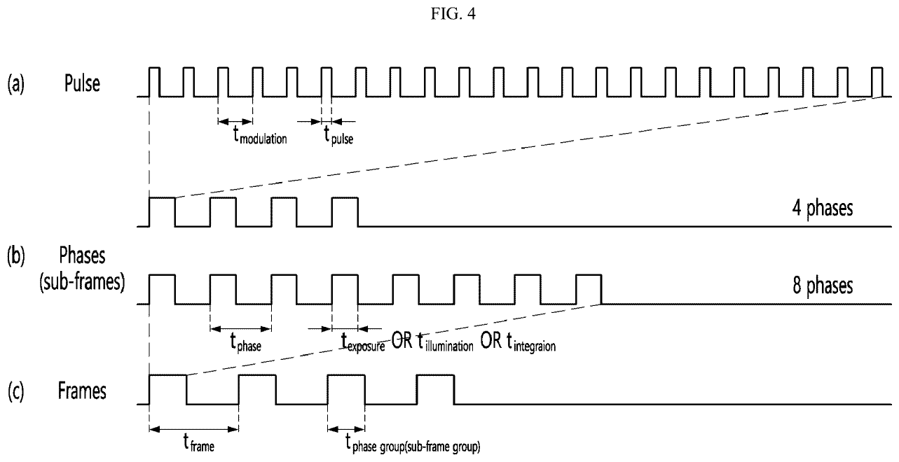

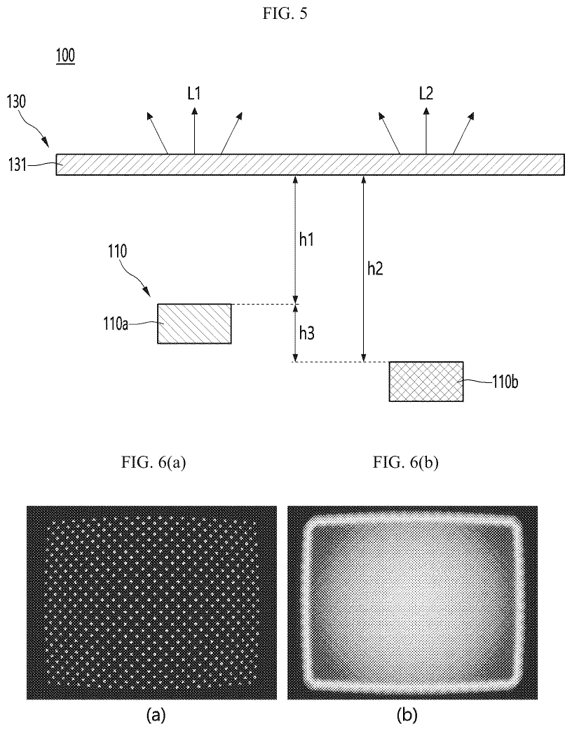

FIG. 2 is a configuration diagram of a light emitting unit and a light receiving unit in a distance measurement camera module according to an embodiment, and FIG. 3 is a diagram showing one side of a light source according to an embodiment. In addition, FIG. 4 is a diagram for explaining an optical signal generated by a light emitting unit in a distance measurement camera module according to an embodiment. In addition, FIG. 5 is a diagram showing the arrangement of a light emitting unit in a distance measurement camera module according to an embodiment, and FIGS. 6(a) and 6(b) are diagrams for explaining a light pattern of the output light according to an embodiment.

Referring to FIGS. 2 to 6(b), the light emitting unit 100 can be placed on a first substrate (not shown). The first substrate is electrically connected to the light emitting unit 100 and can support the light emitting unit 100. The first substrate can be a circuit board. The first substrate can include a wiring layer for supplying power to the light emitting unit 100 and can be a printed circuit board (PCB) formed of a plurality of resin layers. For example, the first substrate can include at least one of a rigid PCB (Rigid PCB), a metal core PCB (MCPCB), a flexible PCB (FPCB), and a rigid flexible PCB (RFPCB).

Additionally, the first substrate can include synthetic resin including glass, resin, epoxy, etc., and can include ceramic with excellent thermal conductivity or metal with an insulated surface. The first substrate can have a shape such as a plate or a lead frame, but is not limited thereto. In addition, although not shown in the drawings, a Zener diode, a voltage regulator, a resistor, etc. can be further disposed on the first substrate, but is not limited thereto.

An insulating layer (not shown) or a protective layer (not shown) can be disposed on the first substrate. The insulating layer or protective layer can be disposed on at least one of one side and the other side of the first substrate.

The light emitting unit 100 can include a light source 110 and a first optical member 130.

The light source 110 can be disposed on the first substrate. The light source 110 can be electrically connected to the first substrate. The light source 110 is physically connected to the first substrate and can be in direct contact with the first substrate.

The light source 110 can include at least one light emitting device selected from a light emitting device. For example, the light source 110 can be a light emitting diode (LED), a vertical cavity surface emitting laser (VCSEL) including an emitter for light emission, or an organic light emitting diode (OLED) and a laser diode (LD).

The light source 110 can include one or more light emitting devices.

For example, the light source 110 can include one light emitting device. In this case, one light emitting device can include a plurality of emitters 111 for light emission. In detail, a plurality of apertures that emit light can be formed on one surface of the light-emitting device, and light formed in the light-emitting device can be emitted through the apertures. Here, the emitter 111 can be defined as the minimum unit that emits light from the light source 110, and can mean the aperture. The plurality of emitters 111 can be arranged according to a predetermined rule on one surface of the light emitting device.

In addition, the light source 110 can include a plurality of light emitting devices. In this case, a plurality of light emitting devices can be arranged according to a set pattern on the first substrate. Additionally, each of the plurality of light emitting devices can include a plurality of emitters 111 for light emission. A plurality of emitters 111 disposed in each of the plurality of light emitting devices can be arranged according to a predetermined rule on one surface of the light emitting device.

The light source 110 can include a plurality of emitters and/or a plurality of channels capable of individually controlling a plurality of light-emitting devices. Accordingly, the light source 110 can selectively drive and control multiple emitters and/or multiple channels.

The light source 110 can have a set size. For example, the plurality of emitters 111 of the light source 110 can have a set diameter (d1) and can have a set pitch interval (P1) with the adjacent emitter 111. At this time, the diameters d1 of the plurality of emitters 111 disposed in the one or more light emitting devices can be the same or different from each other, and the pitch interval P1 can be the same or different from each other. The pitch interval P1 can be the distance between a center of one emitter 111 and a center of the adjacent emitter 111, and can be about 5 μm to about 20 μm.

The light source 110 can emit light in a set wavelength band. In detail, the light source 110 can emit light in a visible light or infrared wavelength band. For example, the light source 110 can emit visible light in a wavelength band of about 380 nm to about 700 nm. Additionally, the light source 110 can emit infrared light in a wavelength band of about 700 nm to about 1 mm.

The light source 110 can emit laser light. In detail, the light emitting device of the light source 110 can emit a plurality of laser lights toward the first optical member 130 disposed on the light source 110. The light emitting elements of the light source 110 can emit light of the same or different wavelengths. Additionally, the light emitting elements of the light source 110 can emit light of the same or different intensity.

The light source 110 can form a set optical signal. For example, referring to FIG. 4(a), the light source 110 can generate light pulses at regular intervals. The light source 110 can generate light pulses with a predetermined pulse repetition period (t_{modulation}) and a predetermined pulse width (tₚᵤₗₛₑ).

Additionally, referring to FIG. 4(b), the light source 110 can generate one phase pulse by grouping a certain number of light pulses. The light source 110 can generate phase pulses having a predetermined phase pulse period (tₚₕₐₛₑ) and a predetermined phase pulse width (tₑₓₚₒₛᵤᵣₑ, tᵢₗₗᵤₘᵢₙₐₜᵢₒₙ, t_{integration}). Here, one phase pulse period (tₚₕₐₛₑ) can correspond to one subframe. A sub-frame can be referred to a phase frame. Phase pulse periods can be grouped into a predetermined number. A method of grouping four phase pulse periods (tₚₕₐₛₑ) can be referred to a 4-phase method. A method of grouping eight periods (tₚₕₐₛₑ) can be referred to an 8-phase method.

Additionally, referring to FIG. 4(c), the light source 110 can generate one frame pulse by grouping a certain number of phase pulses. The light source 110 can generate a frame pulse having a predetermined frame pulse period (t_{frame}) and a predetermined frame pulse width (tₚₕₐₛₑ group (sub-frame group)). Here, one frame pulse period (t_{frame}) can correspond to one frame. Therefore, when photographing an object at 10 FPS, the frame pulse period (t_{frame}) can be repeated 10 times per second. In the 4-phase method, one frame can include four subframes. That is, one frame can be created through four subframes. In the 8-phase method, one frame can include 8 subframes. That is, one frame can be created through 8 subframes. For the above description, the terms light pulse, phase pulse, and frame pulse were used, but the terms are not limited thereto.

The light source 110 can include a first light source 110a and a second light source 110b. Each of the first light source 110a and the second light source 110b can include the light emitting device described above. For example, each of the first light source 110a and the second light source 110b can include one light emitting device or a plurality of light emitting devices as described above.

The first light source 110a and the second light source 110b can emit light in the same wavelength band. Unlike this, the first light source 110a and the second light source 110b can emit light of different wavelength bands.

The first light source 110a and the second light source 110b can include the same or different emitters 111. For example, a total number of emitters 111 included in the first light source 110a can be greater than or equal to a total number of emitters 111 included in the second light source 110b. In addition, the diameter of the emitter 111 included in the first light source 110a can be different from or the same as the diameter of the emitter 111 included in the second light source 110b. In addition, the pitch interval of the emitter 111 included in the first light source 110a can be different from or the same as the pitch interval of the emitter 111 included in the second light source 110b. In addition, a top surface area of the first light source 110a where the emitters are respectively disposed can be different from a top surface area of the second light source 110b. For example, the top surface area of the first light source 110a can be greater than the top surface area of the second light source 110b.

The first light source 110a and the second light source 110b can be disposed on the first substrate. The first light source 110a and the second light source 110b can be disposed on the first substrate and spaced apart from each other in the horizontal direction.

The first light source 110a and the second light source 110b can be disposed between the first substrate and the first optical member 130. A light emission surface of each of the first light source 110a and the second light source 110b can face the first optical member 130. For example, the emitter 111 of each of the first light source 110a and the second light source 110b can be disposed to face the first optical member 130. The first light source 110a and the second light source 110b can emit light toward the first optical member 130.

The first light source 110a and the second light source 110b can be placed at different heights. For example, the first light source 110a can be spaced apart from the first optical member 130 by a first height h1, and the second light source 110b can be spaced apart from the first optical member 130 at a second height h2 that is higher than the first height h1. In detail, an interval between the upper surface of the first light source 110a where the emitter 111 is disposed and a diffractive optical element 131 of the first optical member 130, which will be described later, is the first height h1. The interval between the upper surface of the second light source 110b and the diffractive optical element 131 of the first optical member 130 can be a second height h2.

That is, the first light source 110a can be disposed closer to the first optical member 130 than the second light source 110b. For example, the first light source 110a can be disposed above the second light source 110b by a third height h3. The third height h3 is a height between an upper surface of the first light source 110a and an upper surface of the second light source 110b, and is a difference between the second height h2 and the first height h1.

In detail, the third height h3 can be about 250 [symbol] to about 500 [symbol] to control the output light emitted through each of the first light source 110a and the second light source 110b. In more detail, the third height h3 can be about 300 [symbol] to about 450 [symbol] . Preferably, in order to more effectively control the output light of a point pattern through the first light source 110a and the output light of the surface pattern through the second light source 110b, the third height h3 can be about 350 [symbol] to about 400 [symbol] . At this time, the third height h3 can be about 50% or less of the first height h1 and about 40% or less of the second height h2. In detail, the third height h3 can be about 5% to about 40% of the first height h1, and can be about 5% to about 30% or less of the second height h2. The camera module 1000 according to the embodiment can provide optimal output light to an object located in front by satisfying the above-described ratio of the third height h3 compared to the first and second heights h1 and h2.

The first optical member 130 can be disposed on the light source 110. The first optical member 130 can be disposed on the first light source 110a and the second light source 110b.

The first optical member 130 can control the path of light emitted from the light source 110. For example, the first optical member 130 can include diffractive optic elements (DOE) 131 that controls the path of light using the diffraction phenomenon caused by internal or surface periodic structures.

At least one diffractive optical element 131 can be disposed on the light source 110. For example, one diffractive optical element 131 can be provided. Light emitted from each of the first light source 110a and the second light source 110b can be provided to the diffractive optical element 131.

That is, the light emitted from the first light source 110a can pass through the diffractive optical element 131 and be provided to the object as a set output light, and the light emitted from the second light source 110b can pass through the diffractive optical element 131 and be provided to the object as a set output light.

At this time, the diffractive optical element 131 can be spaced apart from the first light source 110a and the second light source 110b by a first height h1 and a second height h2. Accordingly, the first output light L1 emitted from the first light source 110a and passing through the diffractive optical element 131 can be focused at a position spaced apart from the light emitting unit 100 by a first distance. As shown in FIG. 6(a), the first output light L1 can have the form of a point light source including a point pattern at a position spaced apart from the first distance. That is, the diffractive optical element 131 can receive light emitted from the first light source 110a and transform it into point-shaped light.

In addition, the second output light L2 emitted from the second light source 110b and passing through the diffractive optical element 131 can be focused at a position spaced apart from the light emitting unit 100 by a second distance. Here, the second distance can be closer than the first distance. As shown in FIG. 6(b), the second output light L2 can have the form of a surface light source including a surface pattern at a position spaced apart from the second distance. That is, the diffractive optical element 131 can receive light emitted from the second light source 110b and transform it into surface light.

The first optical member 130 can inhibit light emitted from the light source 110 from being directly irradiated to an object. For example, the diffractive optical element 131 can control the path of light selectively emitted from the first light source 110a and/or the second light source 110b depending on the focusing distance. Accordingly, the embodiment can inhibit the output light from being directly irradiated to sensitive areas such as the eyes and skin of a person located in front of the camera module 1000.

The light emitting unit 100 can further include a first filter (not shown). The first filter can be disposed between the light source 110 and the first optical member 130. The first filter can pass light in a set wavelength band and filter light in a different wavelength band. In detail, the first filter can pass the light emitted from the light source 110 and block light in a wavelength band different from the wavelength band of the light.

Referring again to FIG. 2, the light receiving unit 300 is disposed on a second substrate (not shown) and can include an image sensor 310 and a second optical member 330.

The second substrate can support the light receiving unit 300. The second substrate can be electrically connected to the light receiving unit 300. The second substrate can be a circuit board. The second substrate can include a wiring layer for supplying power to the light receiving unit 300 and can be a printed circuit board (PCB) formed of a plurality of resin layers. For example, the second substrate can include at least one of a rigid PCB (Rigid PCB), a metal core PCB (MCPCB), a flexible PCB (FPCB), and a rigid flexible PCB (RFPCB). The second substrate can be physically and/or electrically connected to the first substrate.

Additionally, the second substrate can include synthetic resin including glass, resin, epoxy, etc., and can include ceramic with excellent thermal conductivity or metal with an insulated surface. The second substrate can have a shape such as a plate or a lead frame, but is not limited thereto. In addition, although not shown in the drawings, a Zener diode, a voltage regulator, a resistor, etc. can be further disposed on the second substrate, but is not limited thereto.

An insulating layer (not shown) or a protective layer (not shown) can be disposed on the second substrate. The insulating layer or protective layer can be disposed on at least one of one side and the other side of the second substrate.

The image sensor 310 can be disposed on the second substrate. The image sensor 310 can directly contact the upper surface of the second substrate and be electrically connected to the second substrate. The image sensor 310 can be electrically connected to the second substrate.

The image sensor 310 can detect light. The image sensor 310 can detect light reflected by an object and incident on the camera module 1000. In detail, the image sensor 310 can detect reflected light emitted from the light emitting unit 100 and reflected and incident on the object. The image sensor 310 can detect light of a wavelength corresponding to the light emitted from the light source 110. For example, the image sensor 310 can detect light in the visible or infrared wavelength band emitted from the light source 110. For example, when the light source 110 emits light in an infrared wavelength band, the image sensor 310 can include an infrared sensor capable of detecting the infrared rays emitted from the light source 110. The image sensor 310 can detect light incident through a second optical member 330, which will be described later. The image sensor 310 can detect light emitted from the light source 110 and reflected on the object, and can detect depth information of the object using time or phase difference.

The second optical member 330 can be disposed on the image sensor 310. The second optical member 330 is spaced apart from the image sensor 310 and can include at least one lens and a housing accommodating the lens. The lens can include at least one material selected from the group consisting of glass and plastic.

The second optical member 330 can be disposed on a light path incident on the light receiving unit 300. That is, the second optical member 330 is disposed between the object and the image sensor 310, and can pass the light emitted from the light source 110 and reflected by the object in the direction of the image sensor 310. To this end, an optical axis of the second optical member 330 can correspond to an optical axis of the image sensor 310.

The light receiving unit 300 can include a second filter (not shown). The second filter can be disposed between the object and the image sensor 310. In detail, the second filter can be disposed between the image sensor 310 and the second optical member 330.

The second filter can pass light in a set wavelength band and filter light in a different wavelength band. In detail, the second filter can pass light of a wavelength corresponding to the output light of the light source 110 among the light incident on the light receiving unit 300 and passing through the second optical member 330, and can block light of a different wavelength band than the output light.

That is, the distance measurement camera module 1000 according to the embodiment can include the diffractive optical element 131 and a plurality of light sources 110 arranged at different intervals from each other. In detail, the light source 110 includes a first light source 110a spaced apart from the first optical member 130 at a first height h1 and a second light source 110b spaced apart from the first optical member 130 at the second height h2. Accordingly, the light emitting unit 100 can selectively drive at least one light source among the first light source 110a and the second light source 110b depending on the distance from the object and provide optimal output light to the object.

Therefore, the camera module 1000 can control the output light according to the distance from the object to inhibit the output light from directly entering sensitive areas of the person, such as the eyes and skin, and it is possible to inhibit incident light and effectively determine the depth information of the object.

In addition, the light emitting unit 100 of the distance measurement camera module 1000 can omit the configuration for controlling the form of output light depending on the distance to the object, for example, an actuator that controls the position of the light source 110 and/or the first optical member 130. Therefore, the light emitting unit 100 and the camera module 1000 can have a slim structure.

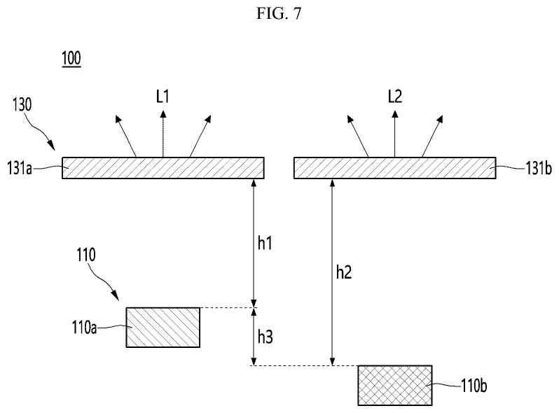

FIG. 7 is a diagram showing another arrangement of a light emitting unit in a distance measurement camera module according to an embodiment. In the description using FIG. 7, descriptions of configurations identical to and similar to those of the camera module described above will be omitted, and configurations similar to those of the camera module described above will be assigned the same reference numerals.

Referring to FIG. 7, the light emitting unit 100 of the camera module 1000 can include a first optical member 130 disposed on the light source 110. The first optical member 130 includes a diffractive optical element (DOE) and can control the path of light emitted from the light source 110.

A plurality of first optical members 130 can be disposed on the light source 110. In detail, the first optical member 130 includes a diffractive optical element 131, and the diffractive optical elements 131 can be provided in numbers corresponding to the plurality of light sources 110. For example, the first optical member 130 can include a first diffractive optical element 131a disposed on the first light source 110a and a second diffractive optical element 131b disposed on the second light source 110b.

The first diffractive optical element 131a can be disposed in a region corresponding to the first light source 110a. The first diffractive optical element 131a can be disposed facing an emission surface of the first light source 110a. For example, the first diffractive optical element 131a can be disposed in a region that overlaps the first light source 110a in a vertical direction. In detail, a center of the first diffractive optical element 131a can overlap a center of the first light source 110a in a vertical direction.

The second diffractive optical element 131b is spaced apart from the first diffractive optical element 131a and can be disposed in a region corresponding to the second light source 110b. The second diffractive optical element 131b can be disposed to face an emission surface of the second light source 110b, and may not face an emission surface of the first light source 110a. For example, the second diffractive optical element 131b can be disposed in a region that overlaps the second light source 110b in the vertical direction. In detail, a center of the second diffractive optical element 131b can overlap a center of the second light source 110b in a vertical direction.

The first diffractive optical element 131a and the second diffractive optical element 131b can be disposed at a same height. For example, a lower surface of the first diffractive optical element 131a and a lower surface of the second diffractive optical element 131b facing the light source 110 can be disposed on the same plane.

In addition, the first light source 110a and the second light source 110b can be disposed at different heights. For example, the first light source 110a can be spaced apart from the first diffractive optical element 131a at a first height h1, and the second light source 110b can be spaced apart from the second diffractive optical element 131b at a second height h2 that is higher than the first height h1. In detail, an interval between the upper surface of the first light source 110a where the emitter 111 is disposed and the lower surface of the first diffractive optical element 131a can be the first height h1, and an interval between the upper surface of the second light source 110b where the emitter 111 is disposed and the lower surface of the second diffractive optical element 131b can be the second height h2.

That is, the first light source 110a can be disposed closer to the first optical member 130 than the second light source 110b. In detail, the first light source 110a can be disposed closer to the first optical member 130 by the third height h3 than the second light source 110b. Here, the third height h3 is a height between the upper surface of the first light source 110a and the upper surface of the second light source 110b, and the third height h3 can be the difference between the second height (h2) and the first height h1.

The third height h3 can be about 250 [symbol] to about 500 [symbol] to control the output light emitted through each of the first light source 110a and the second light source 110b. In more detail, the third height h3 can be about 300 [symbol] to about 450 [symbol] . Preferably, in order to more effectively control the output light of a point pattern through the first light source 110a and the output light of the surface pattern through the second light source 110b, the third height h3 can be about 350 [symbol] to about 400 [symbol] . At this time, the third height h3 can be about 50% or less of the first height h1 and about 40% or less of the second height h2. In detail, the third height h3 can be about 5% to about 40% of the first height h1, and can be about 5% to about 30% or less of the second height h2. The camera module 1000 according to the embodiment can provide optimal output light to an object located in front by satisfying the above-described ratio of the third height h3 compared to the first and second heights h1 and h2.

Accordingly, the light emitted from the first light source 110a can pass through the first diffractive optical element 131a to form a first output light L1, and the light emitted from the second light source 110b can pass through the second diffractive optical element 131b to form a second output light L2. For example, the first output light (L1) formed through the first light source (110a) and the first diffractive optical element (131a) can be focused at a position spaced apart from the light emitting unit (100) by a first distance. The first output light (L1) can have the form of a point light source including a point pattern at the first distance. In addition, the second output light (L2) formed through the second light source (110b) and the second diffractive optical element (131b) can be focused at a position spaced apart from the light emitting unit 100 at the second distance. The second output light (L2) can have the form of a surface light source including a surface pattern at the second distance.

That is, the first diffractive optical element 131a and the second diffractive optical element 131b can inhibit light emitted from each of the first light source 110a and the second light source 110b from being directly irradiated to an object. The first diffractive optical element 131a and the second diffractive optical element 131b are disposed in a region corresponding to the first light source 110a and the second light source 110b, and therefore, it is possible to control the path of light emitted from the first light source 110a and the second light source 110b corresponding to each optical member. Accordingly, the embodiment can inhibit the output light from being directly irradiated to sensitive areas such as the eyes and skin of a person located in front of the camera module 1000.

In addition, the embodiment includes a first diffractive optical element 131a and a second diffractive optical element 131b spaced apart from the first light source 110a and the second light source 110b at different intervals. Accordingly, the embodiment can provide optimal output light to the object by selectively driving at least one light source among the first light source 110a and the second light source 110b depending on the distance to the object.

In addition, the light emitting unit 100 can omit the configuration for controlling the form of output light depending on the distance to the object, for example, an actuator that controls the position of the light source 110 and/or the first optical member 130. Therefore, the light emitting unit 100 and the camera module 1000 can have a slim structure.

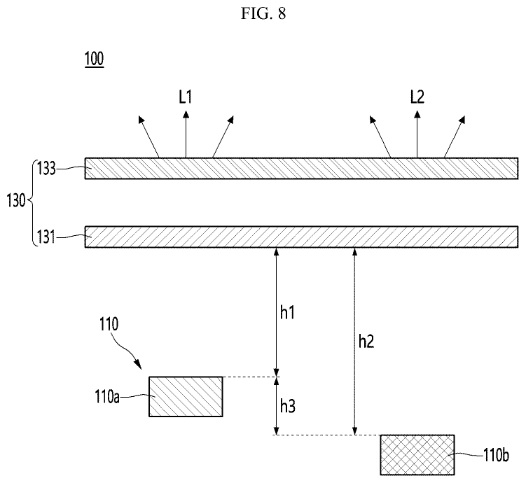

FIGS. 8 to 10 are diagrams showing different arrangements of light emitting units in a distance measurement camera module according to an embodiment. In the description using FIGS. 8 to 10, descriptions of configurations that are the same as those of the distance measurement camera module described above will be omitted, and configurations that are the same as those of the distance measurement camera module described above will be given the same reference numerals.

Referring to FIG. 8, the light emitting unit 100 of the camera module 1000 can include a first optical member 130 disposed on the light source 110.

The first optical member 130 can include a diffractive optical element 131 disposed on the light source 110. At least one diffractive optical element 131 can be disposed on the light source 110. For example, one diffractive optical element 131 can be provided. Light emitted from each of the first light source 110a and the second light source 110b can be provided to the diffractive optical element 131.

Additionally, the first optical member 130 can include a first lens unit 133 disposed on the diffractive optical element 131. The first lens unit 133 can include at least one lens and a housing accommodating the lens. The lens can include at least one of glass and plastic.

At least one first lens unit 133 can be disposed on the diffractive optical element 131. For example, the first lens unit 133 can be provided as one unit. Light emitted from each of the first light source 110a and the second light source 110b can pass through the diffractive optical element 131 and be provided to the first lens unit 133.

The first lens unit 133 can control the path of light emitted from the light source 110. For example, the first lens unit 133 can provide a path for light emitted from the first light source 110a and the second light source 110b and passing through the diffractive optical element 131. The first lens unit 133 can diffuse, scatter, refract, or condense the light that has passed through the diffractive optical element 131.

At least one lens included in the first lens unit 133 can include a collimator lens. The collimator lens can collimate light incident on the first lens unit 133. Here, collimating can mean reducing the divergence angle of light, and ideally can mean making the light proceed in parallel without converging or diverging. That is, the collimator lens can converge the light emitted from the light source 110 into parallel light.

The first light source 110a and the second light source 110b can be placed at different heights. For example, the first light source 110a can be spaced apart from the diffractive optical element 131 at a first height h1, and the second light source 110b can be spaced apart from the diffractive optical element 131 at a second height h2 that is higher than the first height h1. That is, the first light source 110a can be disposed closer to the diffractive optical element 131 by the third height h3 than the second light source 110b.

Accordingly, the light emitted from the first light source (110a) can pass through the diffractive optical element 131 and the first lens unit 133 to form a first output light L1, and the light emitted from the second light source 110b can pass through the diffractive optical element 131 and the first lens unit 133 to form a second output light L2. At this time, the first output light L1 can be focused at a position separated by a first distance from the light emitting unit (100). The first output light (L1) can have the form of a point light source including a point pattern at the first distance. In addition, the second output light (L2) can be focused on a position spaced apart from the light emitting unit (100) by a second distance closer than the first distance. The second output light (L2) can have the form of a surface light source including a surface pattern at the second distance.

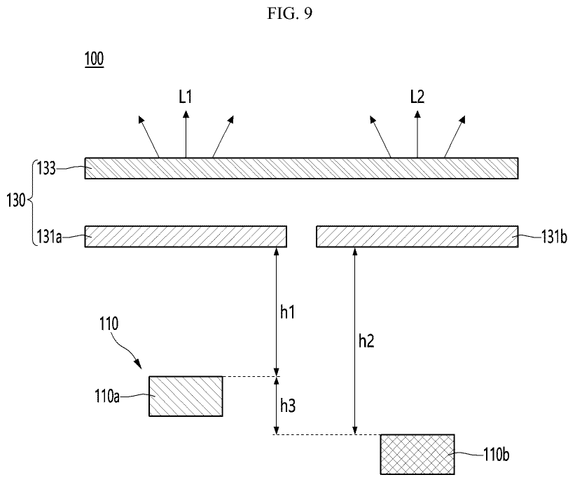

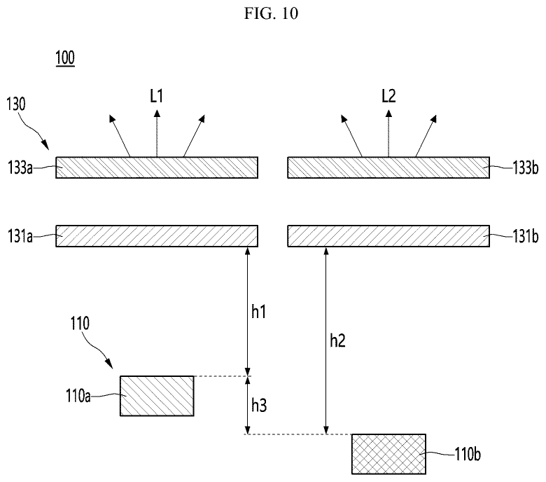

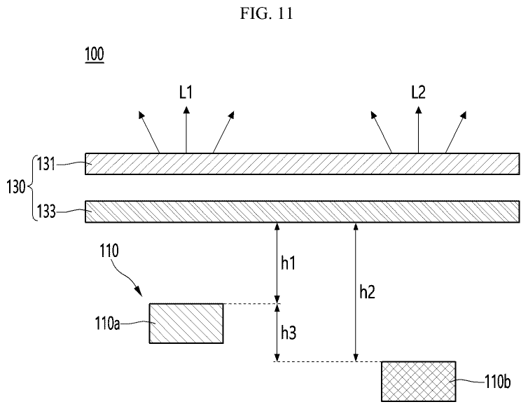

Additionally, referring to FIG. 9, the light emitting unit 100 of the camera module 1000 can include a first optical member 130 disposed on the light source 110.

The first optical member 130 can include a diffractive optical element 131 disposed on the light source 110. A plurality of diffractive optical elements 131 can be disposed on the light source 110. For example, the first optical member 130 includes a first diffractive optical element 131a disposed on the first light source 110a and a second diffractive optical element 131b disposed on the second light source 110b.

The first diffractive optical element 131a can be disposed in a region corresponding to the first light source 110a. The first diffractive optical element 131a can be disposed facing the emission surface of the first light source 110a. Additionally, the second diffractive optical element 131b can be disposed in a region corresponding to the second light source 110b. The second diffractive optical element 131b can be disposed facing the emission surface of the second light source 110b.

The first diffractive optical element 131a and the second diffractive optical element 131b can be disposed at the same height. For example, the lower surface of the first diffractive optical element 131a and the lower surface of the second diffractive optical element 131b facing the light source 110 can be disposed on the same plane.

Additionally, the first optical member 130 can include a first lens unit 133 disposed on the first and second diffractive optical elements 131a and 131b. At least one first lens unit 133 can be disposed on the first and second diffractive optical elements 131a and 131b. For example, the first lens unit 133 can be provided as one unit. Light emitted from each of the first light source 110a and the second light source 110b can pass through the diffractive optical element 131 and be provided to the first lens unit 133.

The first light source 110a and the second light source 110b can be disposed at different heights. For example, the first light source 110a can be spaced apart from the diffractive optical element 131 at a first height h1, and the second light source 110b can be spaced apart from the diffractive optical element 131 at a second height (h2) that is higher than the first height h1. That is, the first light source 110a can be disposed closer to the diffractive optical element 131 by the third height h3 than the second light source 110b.

Accordingly, the light emitted from the first light source 110a can pass through the first diffractive optical element 131a and the first lens unit 133 to form a first output light L1, and the light emitted from the second light source 110b can pass through the second diffractive optical element 131b and the first lens unit 133 to form a second output light L2. At this time, the first output light (L1) can be focused at a position separated by a first distance from the light emitting unit (100). The first output light (L1) can have the form of a point light source including a point pattern at the first distance. In addition, the second output light (L2) can be focused on a position spaced apart from the light emitting unit (100) by a second distance closer than the first distance. The second output light (L2) can have the form of a surface light source including a surface pattern at the second distance.

Additionally, referring to FIG. 10, the light emitting unit 100 of the camera module 1000 can include a first optical member 130 disposed on the light source 110.

The first optical member 130 can include a diffractive optical element 131 disposed on the light source 110. A plurality of diffractive optical elements 131 can be disposed on the light source 110. For example, the first optical member 130 includes a first diffractive optical element 131a disposed on the first light source 110a and a second diffractive optical element 131b disposed on the second light source 110b.

The first diffractive optical element 131a can be disposed in a region corresponding to the first light source 110a. The first diffractive optical element 131a can be disposed facing the emission surface of the first light source 110a. Additionally, the second diffractive optical element 131b can be disposed in a region corresponding to the second light source 110b. The second diffractive optical element 131b can be disposed facing the emission surface of the second light source 110b.

The first diffractive optical element 131a and the second diffractive optical element 131b can be disposed at the same height. For example, the lower surface of the first diffractive optical element 131a and the lower surface of the second diffractive optical element 131b facing the light source 110 can be disposed on the same plane.

Additionally, the first optical member 130 can include a first lens unit 133 disposed on the first and second diffractive optical elements 131a and 131b. A plurality of first lens units 133 can be disposed on the first and second diffractive optical elements 131a and 131b. For example, the first lens unit 133 includes a first-first lens unit 133a disposed on the first diffractive optical element 131a and a first-second lens unit 133b disposed on the second diffractive optical element 131b.

The first-first lens unit 133a can be disposed in a region corresponding to the first light source 110a and the first diffractive optical element 131a. For example, the optical axis of the first-first lens unit 133a can overlap the centers of the first light source 110a and the first diffractive optical element 131a in a vertical direction. Additionally, the first-second lens unit 133b can be disposed in a region corresponding to the second light source 110b and the second diffractive optical element 131b. For example, the optical axis of the first-second lens unit 133b can overlap the centers of the second light source 110b and the second diffractive optical element 131b in a vertical direction.

The first light source 110a and the second light source 110b can be placed at different heights. For example, the first light source 110a can be spaced apart from the diffractive optical element 131 by a first height h1, and the second light source 110b can be spaced apart from the diffractive optical element 131 at a second height (h2) that is higher than the first height (h1). That is, the first light source 110a can be disposed closer to the diffractive optical element 131 by the third height h3 than the second light source 110b.

Accordingly, the light emitted from the first light source (110a) can pass through the first diffractive optical element (131a) and the first-first lens unit (133a) to form a first output light (L1), and the light emitted from the second light source (110b) can pass through the second diffractive optical element (131b) and the first-second lens unit (133b) to form a second output light (L2). At this time, the first output light (L1) can be focused at a position separated by a first distance from the light emitting unit (100). The first output light (L1) can have the form of a point light source including a point pattern at the first distance. In addition, the second output light (L2) can be focused on a position spaced apart from the light emitting unit (100) by a second distance closer than the first distance. The second output light (L2) can have the form of a surface light source including a surface pattern at the second distance.

That is, the camera module 1000 according to the embodiment can include one or more diffractive optical elements 131 and one or more first lens units 133, and can include the diffractive optical element 131 and a plurality of light sources 110 arranged at different intervals.

Accordingly, the light emitting unit 100 can selectively drive at least one light source among the first light source 110a and the second light source 110b depending on the distance from the object and provide optimal output light to the object.

Therefore, the camera module 1000 can control the output light according to the distance from the object to inhibit the output light from directly entering sensitive areas of the person, such as the eyes and skin, and it is possible to inhibit incident light and effectively determine the depth information of the object.

In addition, the light emitting unit 100 of the distance measurement camera module 1000 can omit the configuration for controlling the form of output light depending on the distance to the object, for example, an actuator that controls the position of the light source 110 and/or the first optical member 130. Therefore, the light emitting unit 100 and the camera module 1000 can have a slim structure.

FIGS. 11 to 13 are diagrams showing different arrangements of light emitting units in a distance measurement camera module according to an embodiment. In the description using FIGS. 11 to 13, descriptions of configurations that are the same as those of the distance measurement camera module described above will be omitted, and configurations that are the same as those of the distance measurement camera module described above will be given the same reference numerals.

Referring to FIG. 11, the light emitting unit 100 of the camera module 1000 can include a first optical member 130 disposed on the light source 110.

The first optical member 130 can include a diffractive optical element 131 disposed on the light source 110. At least one diffractive optical element 131 can be disposed on the light source 110. For example, the diffractive optical element 131 can be provided as one unit. Light emitted from each of the first light source 110a and the second light source 110b can be provided to the diffractive optical element 131.

Additionally, the first optical member 130 can include a first lens unit 133 disposed between the light source 110 and the diffractive optical element 131. The first lens unit 133 can be provided as one unit. Light emitted from each of the first light source 110a and the second light source 110b can pass through the first lens unit 133 and be provided to the diffractive optical element 131.

The first light source 110a and the second light source 110b can be disposed at different heights. For example, the first light source (110a) can be spaced apart from the first lens unit (133) at a first height (h1), and the second light source (110b) can be spaced apart from the first lens unit (133) at a second height h2 that is higher than the first height (h1). That is, the first light source 110a can be disposed closer to the first lens unit 133 than the second light source 110b by the third height h3.

The third height h3 can be about 250 [symbol] to about 500 [symbol] to control the output light emitted through each of the first light source 110a and the second light source 110b. In more detail, the third height h3 can be about 300 [symbol] to about 450 [symbol] . Preferably, in order to more effectively control the output light of a point pattern through the first light source 110a and the output light of the surface pattern through the second light source 110b, the third height h3 can be about 350 [symbol] to about 400 [symbol] . At this time, the third height h3 can be about 50% or less of the first height h1 and about 40% or less of the second height h2. In detail, the third height h3 can be about 5% to about 40% of the first height h1, and can be about 5% to about 30% or less of the second height h2. The camera module 1000 according to the embodiment can provide optimal output light to an object located in front by satisfying the above-described ratio of the third height h3 compared to the first and second heights h1 and h2.

Accordingly, the light emitted from the first light source 110a can pass through the first lens unit 133 and the diffractive optical element 131 to form a first output light (L1), and the light emitted from the second light source 110b can pass through the first lens unit 133 and the diffractive optical element 131 to form a second output light (L2). At this time, the first output light (L1) can be focused at a position separated by a first distance from the light emitting unit (100). The first output light (L1) can have the form of a point light source including a point pattern at the first distance. In addition, the second output light (L2) can be focused on a position spaced apart from the light emitting unit (100) by a second distance closer than the first distance. The second output light (L2) can have the form of a surface light source including a surface pattern at the second distance.

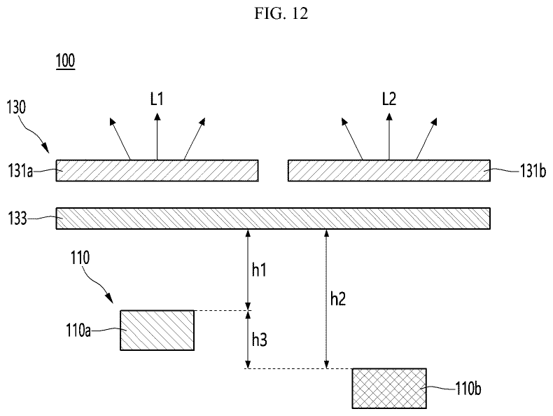

In addition, referring to FIG. 12, the light emitting unit 100 of the camera module 1000 can include a first optical member 130 disposed on the light source 110.

The first optical member 130 can include a diffractive optical element 131 disposed on the light source 110. A plurality of diffractive optical elements 131 can be disposed on the light source 110. For example, the first optical member 130 includes a first diffractive optical element 131a disposed on the first light source 110a and a second diffractive optical element 131B disposed on the second light source 110b. It can include an element 131b.

The first diffractive optical element 131a can be disposed in a region corresponding to the first light source 110a. The first diffractive optical element 131a can be disposed facing the emission surface of the first light source 110a. Additionally, the second diffractive optical element 131b can be disposed in a region corresponding to the second light source 110b. The second diffractive optical element 131b can be disposed facing the emission surface of the second light source 110b.

The first diffractive optical element 131a and the second diffractive optical element 131b can be disposed at the same height. For example, the lower surface of the first diffractive optical element 131a and the lower surface of the second diffractive optical element 131b facing the light source 110 can be disposed on the same plane.

Additionally, the first optical member 130 can include a first lens unit 133 disposed on the light source 110 and the first and second diffractive optical elements 131a and 131b. At least one first lens unit 133 can be disposed on the first and second diffractive optical elements 131a and 131b. For example, the first lens unit 133 can be provided as one unit. The light emitted from each of the first light source (110a) and the second light source 110b can pass through the first lens unit 133 and be provided to the first and second diffractive optical elements 131a and 131b, respectively.

The first light source 110a and the second light source 110b can be disposed at different heights. For example, the first light source (110a) can be spaced apart from the first lens unit (133) by a first height (h1), and the second light source (110b) can be spaced apart from the first lens unit (133) by a second height (h2) that is higher than the first height (h1). That is, the first light source 110a can be disposed closer to the first lens unit 133 than the second light source 110b by the third height h3.

Accordingly, the light emitted from the first light source (110a) can pass through the first lens unit (133) and the first diffractive optical element (131a) to form a first output light (L1), and the light emitted from the second light source (110b) can pass through the first lens unit (133) and the second diffractive optical element (131b) to form a second output light (L2). At this time, the first output light (L1) can be focused at a position spaced apart from the light emitting unit 100 by a first distance, and can have the form of a point light source including a point pattern at the first distance. In addition, the second output light (L2) can be focused on a position spaced apart from the light emitting unit 100 by a second distance closer than the first distance, and can have the form of a surface light source including a surface pattern at the second distance.

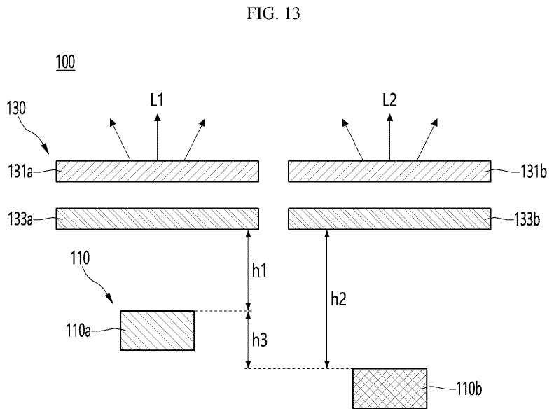

In addition, referring to FIG. 13, the light emitting unit 100 of the camera module 1000 can include a first optical member 130 disposed on the light source 110.

The first optical member 130 can include a diffractive optical element 131 disposed on the light source 110. A plurality of diffractive optical elements 131 can be disposed on the light source 110. For example, the first optical member 130 can include a first diffractive optical element 131a disposed on the first light source 110a and a second diffractive optical element 131b disposed on the second light source 110b.

The first diffractive optical element 131a can be disposed in a region corresponding to the first light source 110a. The first diffractive optical element 131a can be disposed facing the emission surface of the first light source 110a. Additionally, the second diffractive optical element 131b can be disposed in a region corresponding to the second light source 110b. The second diffractive optical element 131b can be disposed facing the emission surface of the second light source 110b.

The first diffractive optical element 131a and the second diffractive optical element 131b can be disposed at the same height. For example, the lower surface of the first diffractive optical element 131a and the lower surface of the second diffractive optical element 131b facing the light source 110 can be disposed on the same plane.

Additionally, the first optical member 130 can include a first lens unit 133 disposed between the light source 110 and the diffractive optical elements 131a and 131b. A plurality of first lens units 133 can be disposed on the first and second light sources 110a and 110b. For example, the first lens unit 133 includes a first-first lens unit 133a disposed between the first light source 110a and the first diffractive optical element 131a and a first-second lens unit 133b disposed between the second light source 110b and the second diffractive optical element 131b.

The first-first lens unit 133a can be disposed in a region corresponding to the first light source 110a and the first diffractive optical element 131a. For example, the optical axis of the first-first lens unit 133a can overlap the centers of the first light source 110a and the first diffractive optical element 131a in a vertical direction. Additionally, the first-second lens unit 133b can be disposed in a region corresponding to the second light source 110b and the second diffractive optical element 131b. For example, the optical axis of the first-second lens unit 133b can overlap the centers of the second light source 110b and the second diffractive optical element 131b in a vertical direction.

The first light source 110a and the second light source 110b can be disposed at different heights. For example, the first light source 110a can be spaced apart from the first lens unit (133) by a first height (h1), and the second light source (110b) can be spaced apart from the first lens unit (133) by a second height (h2) that is higher than the first height (h1). That is, the first light source 110a can be disposed closer to the first lens unit 133 by the third height h3 than the second light source 110b.

Accordingly, the light emitted from the first light source (110a) can pass through the first lens unit (133) and the first diffractive optical element (131a) to form a first output light (L1), and the light emitted from the second light source (110b) can pass through the first lens unit (133) and the second diffractive optical element (131b) to form a second output light (L2). At this time, the first output light (L1) can be focused at a position spaced apart from the light emitting unit 100 by a first distance, and can have the form of a point light source including a point pattern at the first distance. In addition, the second output light (L2) can be focused on a position spaced apart from the light emitting unit 100 by a second distance closer than the first distance, and can have the form of a surface light source including a surface pattern at the second distance.

That is, the camera module 1000 according to the embodiment can include one or more first lens units 133 and one or more diffractive optical elements 131, and can include a plurality of light sources 110 arranged at different intervals from the first lens unit 133.

Accordingly, the light emitting unit 100 selectively drives at least one light source among the first light source 110a and the second light source 110b according to the distance from the object to provide optimal output to the object. Light can be provided.

Accordingly, the light emitting unit 100 can selectively drive at least one light source among the first light source 110a and the second light source 110b depending on the distance from the object and provide optimal output light to the object.

Therefore, the camera module 1000 can control the output light according to the distance from the object to inhibit the output light from directly entering sensitive areas of the person, such as the eyes and skin, and it is possible to inhibit incident light and effectively determine the depth information of the object.

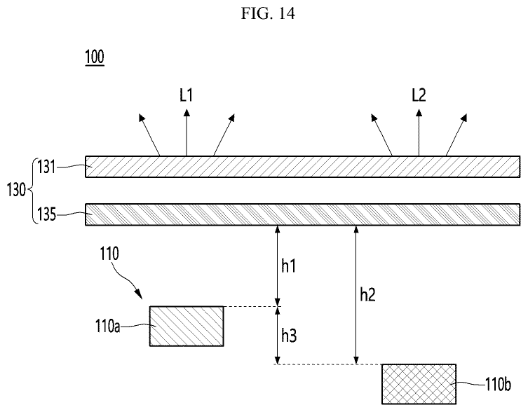

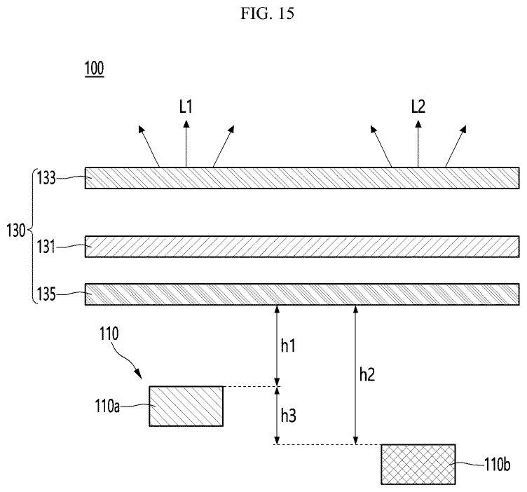

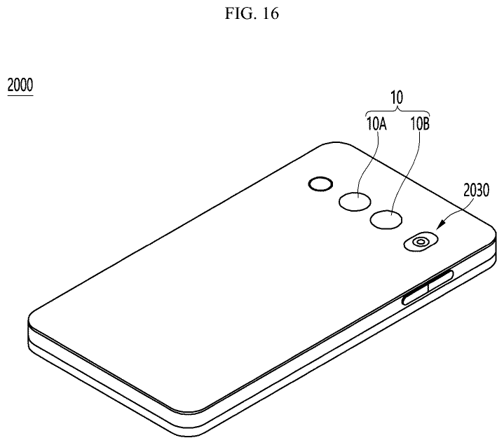

FIGS. 14 and 15 are diagrams showing different arrangements of light emitting units in a distance measurement camera module according to an embodiment. In the description using FIGS. 14 and 15, descriptions of configurations identical to and similar to the distance measurement camera module described above will be omitted, and identical reference numerals will be given to identical configurations.

Referring to FIG. 14, the light emitting unit 100 of the camera module 1000 can include a first optical member 130 disposed on the light source 110.

The first optical member 130 can include a diffractive optical element 131 disposed on the light source 110. At least one diffractive optical element 131 can be disposed on the light source 110. For example, the diffractive optical element 131 can be provided as one unit as shown in FIGS. 5, 8, and 11, or can be provided as a plurality corresponding to the number of light sources 110, as shown in FIGS. 7, 9, 10, 12, and 13.

Additionally, the first optical member 130 can include a liquid crystal layer 135 disposed on the light source 110. The liquid crystal layer 135 can be disposed between the light source 110 and the diffractive optical element 131. The liquid crystal layer 135 can include a plurality of liquid crystal molecules and an alignment layer for aligning the liquid crystal molecules. The liquid crystal layer 135 can control light transmittance by changing the arrangement of the liquid crystal molecules in response to applied power.

The first light source 110a and the second light source 110b can be disposed at different heights. For example, the first light source 110a can be spaced apart from the liquid crystal layer 135 by a first height h1, and the second light source 110b can be spaced apart from the liquid crystal layer 135 by a second height (h2) that is higher than the first height (h1). That is, the first light source 110a can be disposed closer to the liquid crystal layer 135 by the third height h3 than the second light source 110b.

The third height h3 can be about 250 [symbol] to about 500 [symbol] to control the output light emitted through each of the first light source 110a and the second light source 110b. In more detail, the third height h3 can be about 300 [symbol] to about 450 [symbol] . Preferably, in order to more effectively control the output light of a point pattern through the first light source 110a and the output light of the surface pattern through the second light source 110b, the third height h3 can be about 350 [symbol] to about 400 [symbol] . At this time, the third height h3 can be about 50% or less of the first height h1 and about 40% or less of the second height h2. In detail, the third height h3 can be about 5% to about 40% of the first height h1, and can be about 5% to about 30% or less of the second height h2. The camera module 1000 according to the embodiment can provide optimal output light to an object located in front by satisfying the above-described ratio of the third height h3 compared to the first and second heights h1 and h2.

Accordingly, the light emitted from the first light source (110a) can pass through the liquid crystal layer 135 and the diffractive optical element 131 to form a first output light (L1), and the light emitted from the second light source (110b) can pass through the liquid crystal layer 135 and the diffractive optical element 131 to form a second output light (L2). At this time, the first output light (L1) can be focused at a position spaced apart from the light emitting unit 100 by a first distance, and can have the form of a point light source including a point pattern at the first distance. In addition, the second output light (L2) can be focused on a position spaced apart from the light emitting unit 100 by a second distance closer than the first distance, and can have the form of a surface light source including a surface pattern at the second distance.

The first optical member 130 includes a liquid crystal layer 135, thereby guiding the light emitted from each of the first light source 110a and the second light source 110b to a set region. For example, the liquid crystal layer 135 controls the light transmittance depending on a region so that the light emitted from the first light source (110a) is transmitted to the diffractive optical element 131 corresponding to the second light source (110b) and/or inhibit incident on a region of the first lens unit 133, and the light emitted from the second light source (110b) can be inhibited from being incident on a region of the diffractive optical element 131 and/or the first lens unit 133 corresponding to the first light source (110a). Accordingly, the camera module 1000 can more effectively determine depth information of an object located in front and provide safe output light to the object.

Referring to FIG. 15, the light emitting unit 100 of the camera module 1000 can include a first optical member 130 disposed on the light source 110.

The first optical member 130 can include a diffractive optical element 131 disposed on the light source 110. At least one diffractive optical element 131 can be disposed on the light source 110. For example, the diffractive optical element 131 can be provided as one unit as shown in FIGS. 5, 8, and 11, or can be provided in plural numbers corresponding to the number of light sources 110, as shown in FIGS. 7, 9, 10, 12, and 13.

Additionally, the first optical member 130 can include a first lens unit 133 disposed on the diffractive optical element 131. At least one first lens unit 133 can be disposed on the diffractive optical element 131. For example, the first lens unit 133 can be provided as one unit on the diffractive optical element 131, as shown in FIGS. 8 and 11, or can be provided in plural numbers corresponding to the number of light sources 110, as shown in FIGS. 7, 9, 10, 12, and 13.

Additionally, the first optical member 130 can include a liquid crystal layer 135 disposed on the light source 110. The liquid crystal layer 135 can be disposed between the light source 110 and the diffractive optical element 131. The liquid crystal layer 135 can control light transmittance by changing the arrangement of the liquid crystal molecules in response to applied power.

That is, the camera module 1000 according to the embodiment can include at least one selected from the liquid crystal layer 135, at least one diffractive optical element 131, and at least one first lens unit 133. Additionally, the camera module 1000 can include a plurality of light sources 110 arranged at different intervals from the liquid crystal layer 135.

Accordingly, the light emitting unit 100 can selectively drive at least one light source among the first light source 110a and the second light source 110b depending on the distance from the object and provide optimal output light to the object.

Therefore, the camera module 1000 can control the output light according to the distance from the object to inhibit the output light from directly entering sensitive areas of the person, such as the eyes and skin, and it is possible to inhibit incident light and effectively determine the depth information of the object.

In addition, the light emitting unit 100 of the distance measurement camera module 1000 can omit the configuration for controlling the form of output light depending on the distance to the object, for example, an actuator that controls the position of the light source 110 and/or the first optical member 130. Therefore, the light emitting unit 100 and the camera module 1000 can have a slim structure.

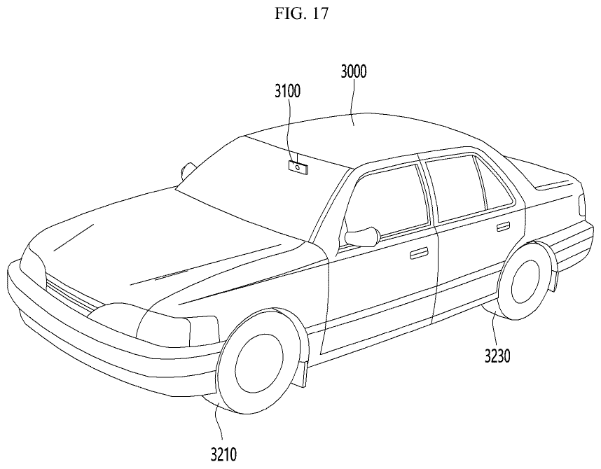

FIGS. 16 and 17 are perspective views of a mobile terminal and a vehicle to which a distance measurement camera module according to an embodiment is applied.

Referring to FIGS. 16 and 17, the distance measurement camera module according to the embodiment can be applied to optical devices.

First, referring to FIG. 16, the distance measurement camera module 1000 according to the embodiment can be applied to the mobile terminal 2000. The mobile terminal 2000 according to the embodiment can have a first camera module 10A and a second camera module 10B disposed at a rear surface.

The first camera module 10A can include a light emitting unit 100 and a light receiving unit 300 as the camera module described above. The first camera module 10A can be a time of flight (TOF) camera.

The second camera module 10B can include an image capturing function. Additionally, the second camera module 10B can include at least one of an auto focus, zoom function, and OIS function. The second camera module 10B can process image frames of still images or moving images obtained by an image sensor in shooting mode or video call mode. The processed image frame can be displayed on a certain display unit and stored in memory. Additionally, although not shown in the drawing, a camera can be placed at a front surface of the mobile terminal 2000.

A flash module 2030 can be placed at the rear surface of the mobile terminal 2000. The flash module 2030 can include a light emitting device inside that emits light. The flash module 1530 can be operated by operating a camera of a mobile terminal or by user control.

Accordingly, the user can photograph an object using the mobile terminal 2000 and display it through a display member (not shown) of the mobile terminal 2000. Additionally, the user can effectively determine the depth information of the object using the first camera module 10A and detect the depth information of the object in real time.

Additionally, referring to FIG. 17, the camera module 1000 according to the embodiment can be applied to the vehicle 3000.

The vehicle 3000 according to the embodiment can include wheels 3210 and 3230 that rotate by a power source and a predetermined sensor. The sensor can include a camera sensor 3100, and the camera sensor 3100 can be a camera sensor including the camera module 1000 described above.

The vehicle 3000 according to the embodiment can obtain image information and depth information through a camera sensor 3100 that captures a front image or surrounding image. Additionally, the vehicle 3000 can determine the lane identification situation using the acquired image and depth information and create a virtual lane when the lane is not identified.

For example, the camera sensor 3100 can acquire a front image by photographing the front of the vehicle 3000, and a processor (not shown) can acquire image information by analyzing objects included in the front image.

In addition, when the image captured by the camera sensor 3100 photographs objects such as lanes, adjacent vehicles, driving obstacles, and central separators, curbstones, and street trees corresponding to indirect road indicators, the processor can detect depth information as well as image information of the object. That is, the embodiment can provide more specific and accurate information on an object to a passenger of the vehicle 3000.

Features, structures, effects, etc. described in the embodiments above are included in at least one embodiment, and are not necessarily limited to only one embodiment. Furthermore, the features, structures, and effects illustrated in each embodiment can be combined or modified with respect to other embodiments by those skilled in the art in the field to which the embodiments belong. Therefore, contents related to these combinations and modifications should be construed as being included in the scope of the embodiments.

Although the above has been described centering on the embodiment, this is only an example and does not limit the embodiment, and those skilled in the art in the field to which the embodiment belongs can find various things not exemplified above to the extent that they do not deviate from the essential characteristics of the embodiment. It will be appreciated that variations and applications of branches are possible. For example, each component specifically shown in the embodiment can be modified and implemented. And differences related to these modifications and applications should be construed as being included in the scope of the embodiments set forth in the appended claims.

1. A distance measurement camera module, comprising:
a light emitting unit; and
a light receiving unit including an image sensor,
wherein the light emitting unit comprises:
a substrate;
a plurality of light sources disposed on the substrate; and
a first optical member disposed on the plurality of light sources,
wherein the plurality of light sources comprises:
a first light source spaced apart from the first optical member on the substrate at a first height; and
a second light source spaced apart from the first optical member on the substrate at a second height different from the first height,
wherein the first light source is fixedly disposed on the substrate at a position spaced apart from the first optical member at the first height, and
wherein the second light source is fixedly disposed on the substrate at a position spaced apart from the first optical member at the second height.

2. The distance measurement camera module of claim 1, wherein the first height is smaller than the second height.

3. The distance measurement camera module of claim 2, wherein a first output light emitted from the first light source and emitted through the first optical member forms light of a point pattern at a position spaced apart by a first distance, and
wherein a second output light emitted from the second light source and emitted through the first optical member forms light of a surface pattern at a position spaced apart by a second distance.

4. The distance measurement camera module of claim 3, wherein the second distance is closer than the first distance.

5. The distance measurement camera module of claim 1, wherein the first optical member includes diffractive optical elements (DOE, Diffractive Optic Elements), and
wherein a number of the diffractive optical elements is less than or equal to a number of the plurality of light sources.

6. The distance measurement camera module of claim 5, wherein the diffractive optical elements include:
a first diffractive optical element disposed on the first light source; and
a second diffractive optical element disposed on the second light source and spaced apart from the first diffractive optical element.

7. The distance measurement camera module of claim 5, wherein the first optical member includes a first lens unit disposed on the diffractive optical elements and includes at least one lens.

8. The distance measurement camera module of claim 5, wherein the first optical member includes a first lens unit disposed between the plurality of light sources and the diffractive optical elements including at least one lens.

9. The distance measurement camera module of claim 7, wherein the first lens unit includes:
a first-first lens unit disposed at a region corresponding to the first light source; and
a first-second lens unit disposed at a region corresponding to the second light source and spaced apart from the first-first lens unit.

10. The distance measurement camera module of claim 1, wherein the first optical member includes a liquid crystal layer disposed between the plurality of light sources and the diffractive optical elements.

11. The distance measurement camera module of claim 2, wherein a difference between the first height and the second height is 250 [symbol] to 500 [symbol] .

12. The distance measurement camera module of claim 2, wherein a difference between the first height and the second height satisfies a range of 5% to 40% of the first height.

13. The distance measurement camera module of claim 2, wherein a difference between the first height and the second height satisfies a range of 5% to 30% of the second height.

14. The distance measurement camera module of claim 2, wherein an output light emitted from the first light source is focused at a first position, and
wherein an output light emitted from the second light source is focused at a second position different from the first position.

15. A mobile terminal comprising:
a case; and
a distance measuring camera module according to claim 1 accommodated in the case.
